(19) United States
(12) Patent Application Publication
(10) Pub. No.: US 2001/0011025 A1
(43) Pub. Date: Aug. 2, 2001

(54) Receiver wearable on user's wrist

(76) Inventors: Yuji Ohki, Tokyo (JP); Atsushi Shigemura, Tokyo (JP); Eiji Nakazawa, Tokyo (JP)

Correspondence Address: FRISHAUF, HOLTZ, GOODMAN, LANGER & CHICK, P.C., 767 Third Avenue - 25th Floor, New York, NY, 10017, US

(21) Appl. No.: 09/756,025

(22) Filed: Jan. 5, 2001

(30) Foreign Application Priority Data
Jan. 31, 2000 (JP) 22447 / 2000
Mar. 22, 2000 (JP) 80375 / 2000

(51) Int. Cl. H04B 1/38; H04B 7/185

(52) U.S. Cl. 455/556; 455/11.1; 455/13.1; 455/550; 455/344

(57) ABSTRACT

The present invention provides a radio receiver in which a first device worn on a user's wrist receives a radio voice signal, converts the received radio voice signal to an infrared signal, and transmits the infrared signal to a second device worn on a user's finger. The second device converts the received infrared signal to a voice signal, which is then output audibly as a corresponding sound. A microphone provided on a wristband receives voice and converts the same to a radio voice signal, which is then transmitted. Since the receiver has such arrangement, the receiver itself is reduced greatly in size and weight. The receiver is capable of receiving signals and making telephonic communication with others in a very natural style, which does not give an impression of strangeness to those around the receiver.

### BACKGROUND OF THE INVENTION

1. Field of the Invention

The present invention relates to receivers wearable on a user's wrist for receiving radio waves of voice/picture information and for functioning, for example, as a portable telephone or TV phone.

2. Description of the Related Art

Portable telephones are hitherto known which are capable of telephonic communication using radio waves. A portable telephone of this type has a long box-like body such that when its speaker is applied to a user's ear, its microphone is disposed near the user's mouth. Recently, articles of this type having a size suitable for being accommodated within a breast pocket of the user's jacket are commercially available.

Such telephone is, however, troublesome to take out from the pocket. In such a case, it can be inadvertently dropped and broken or it can be lost. Thus, recently, electronic devices have been developed which are each wearable directly on a user's body such as, for example, a wristwatch-type portable telephone which comprises a wristwatch having a telephone function.

Among the box-like portable telephones, portable TV phones have been proposed which are capable of performing telephonic communication as well as sending/receiving picture data, for example, by electronic mail or via the Internet and/or sending/receiving (dynamic) picture data for a TV phone.

In the wristwatch-type portable telephone, all the elements of the portable telephone such as an antenna, a microphone and a speaker are required to be disposed within the wristwatch. Thus, the wristwatch itself is large-sized and weighty, undesirably.

Especially, in the wristwatch-type portable telephone, when the user disposes its microphone close to the user's mouth for talking purposes, its speaker cannot be brought close to the user's ear due to the shape of the telephone. Thus, earphones must be used or the speaker itself is required to be large-sized to provide a large volume of sound. Thus, the telephone would necessarily become large-sized and weighty.

With the TV phone which is required to send/receive talking voice as well as picture data and simultaneously required to listen to and view telephonic voice and a picture, respectively, it is difficult to send/receive voice because the microphone and speaker are small-sized when the TV phone is moved away from the user's face in order to view the displayed picture. Conversely, when the TV phone is brought close to the user's face (ear or mouth) to send/receive voice well, the displayed picture is difficult to view now.

When the TV phone is moved away from the user's face to view the displayed picture, the received voice is difficult to reach the microphone of the TV phone and environmental noise would be picked up and mixed with the telephonic communication, undesirably.

### SUMMARY OF THE INVENTION

It is therefore an object of the present invention to provide a wrist wearable-type receiver reduced greatly in size and weight to thereby solve the above problems.

It is another object of the present invention to provide a portable receiver capable of sending/receiving voice and picture data very well and viewing a corresponding picture very well.

In order to achieve the above objects, the present invention provides a receiver comprising:

a first or wrist-wearable type device comprising radio receiving means for receiving radio waves, converting means for converting the radio signal received by the radio wave receiving means to receive data and for outputting the same, and radio transmitting means for converting the receive data outputted by the converting means to a radio signal to transmit the same; and

a second or ring-wearable type device comprising radio receiving means for receiving the radio signal transmitted by the radio transmitting means of the first device, and sound generating means for generating a sound based on the radio signal received by the radio receiving means.

According to such arrangement of the invention, the first or wrist-wearable type device is capable of receiving radio waves and the user is able to listen to a corresponding sound with the sound generating means of the second device worn on the user's finger. Thus, the sound generating means is applied to the user's ear and only required to generate a small volume of sound. Thus, it can be very small in size. In addition, no means for producing a large volume of sound is required to be incorporated into the first or wrist-type device, and the first device can be reduced in size and weight, advantageously.

### BRIEF DESCRIPTION OF THE DRAWINGS

For a better understanding of the present invention, reference is made of a detailed description to be read in conjunction with the accompanying drawings, in which:

FIGS. 1-13 illustrate a first embodiment of the present invention;

FIG. 1 shows a circuit diagram of a receiver as a first embodiment of the present invention;

FIG. 2 is a plan view of a first or wristband-type device;

FIG. 3 is a back view of the first device;

FIG. 4 is a side view of the first device where its operation means is seen;

FIG. 5 is a side view of the first device where its radio transmitting means is seen;

FIG. 6 is a cross-sectional view taken along a line A-A of FIG. 1;

FIG. 7 is a perspective view of a second or finger-wearable device where a radio wave receiving means is seen;

FIG. 8 is a perspective view of the second device where its sound hole is seen;

FIG. 9 is a perspective view of electronic parts to be accommodated within the second device;

FIG. 10 is a substantially perspective view of the second device, showing how the electronic parts are disposed;

FIG. 11 is a side view of a user who uses the inventive receiver worn on his or her left hand that is applied to his or her corresponding cheek;

FIG. 12 is a front view of the user who uses the receiver worn on his or her left hand that is applied to his or her corresponding cheek;

FIG. 13 illustrates a use of the receiver worn on the user's left hand whose palm faces this side;

FIG. 14-21 illustrate a second embodiment of the present invention;

FIG. 14 shows a circuit diagram of a receiver as the second embodiment of the present invention;

FIG. 15 is a back view of a first device of the receiver;

FIG. 16 is a side view of the first device where a radio image transmission/reception means of the receiver is seen;

FIG. 17 is a substantially perspective view of a third device before its image pickup unit is rotated;

FIG. 18 is a substantially perspective view of the third device after the image pickup unit is rotated for image pickup;

FIG. 19 is a side view of a user who uses the inventive receiver worn on his or her left hand that is applied to his or her corresponding cheek;

FIG. 20 is a front view of the user who uses the receiver; and

FIG. 21 illustrates a use of the first device worn on the user's left hand whose palm faces this side.

### DETAILED DESCRIPTION OF THE PREFERRED EMBODIMENT

Referring now to the drawings, first and second embodiments of the present invention will be described in detail.

### First Embodiment

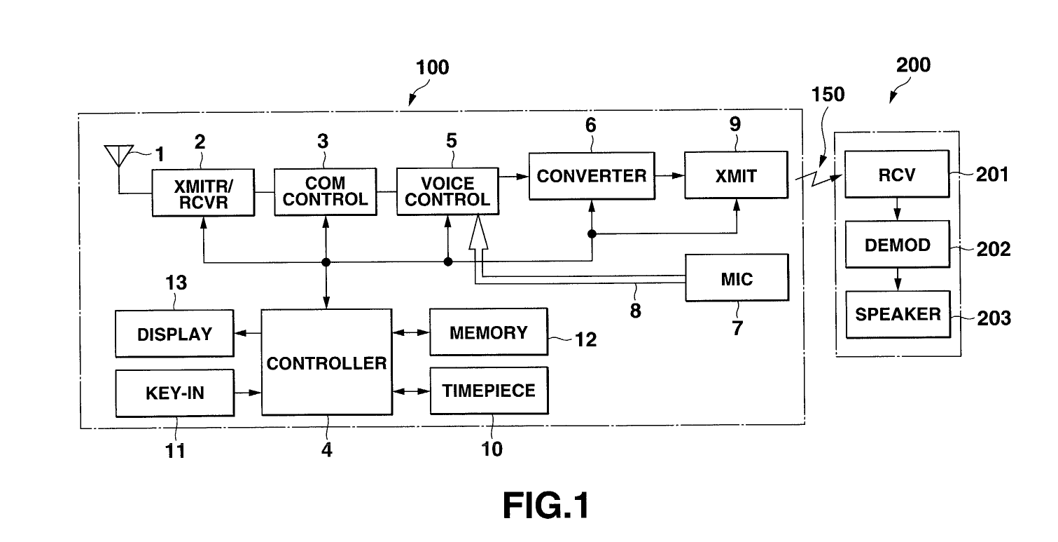

Referring FIGS. 1-13, the first embodiment of the present invention will be described next. FIG. 1 is a circuit diagram of the inventive receiver, which is constituted as an electronic device wearable on a user's body and having the functions of a portable telephone. The receiver comprises a first or wristwatch-type device 100 to be worn on the user's wrist and a second or finger-wearable device 200 to be worn on any finger of the user's hand (preferably, middle finger).

The wristwatch-type device implies that the device is wearable on the user's wrist, and is not limited about whether it has a timepiece function. The finger-wearable type device implies that it is wearable on a finger, but is not necessarily required to take the form of a doughnut like a finger ring.

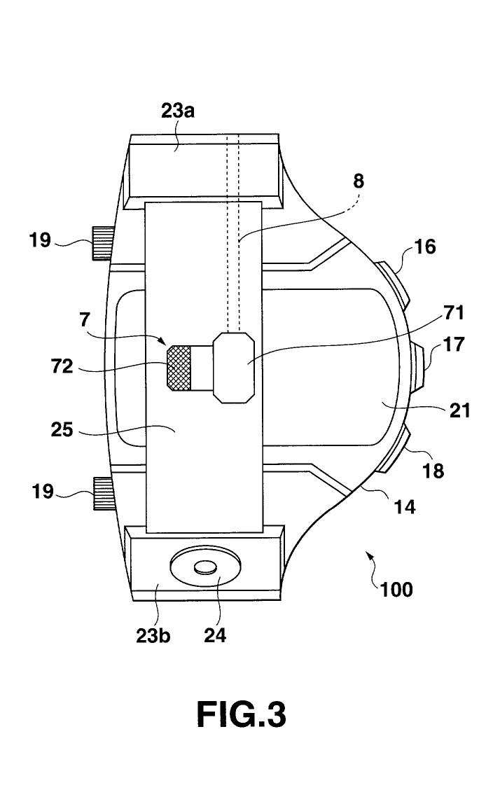

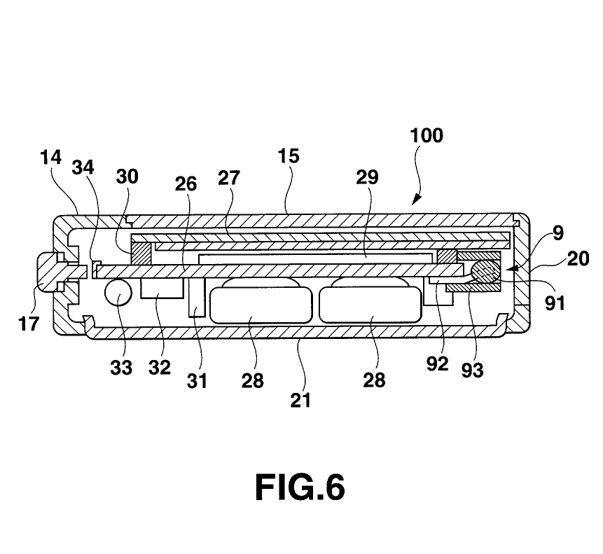

The first device 100 has a transmission/reception antenna 1 used to send/receive radio waves to/from a telephone base station. The antenna 1 is attached to a circuit board 26 (FIG. 6), but may be disposed within a band 25 (FIGS. 3-5) to be described later.

The antenna 1 is coupled to a transmission/reception unit 2 The transmission/reception unit 2 converts a radio signal received by the antenna 1 to an electric signal, and delivers the signal as received data to a communication control unit 3. The transmission/reception unit 2 also converts an electric signal received from the communication control unit 3 to a radio wave signal, and delivers it to the antenna 1 for transmitting purposes.

The data sent/received via the antenna 1 include voice data for telephonic communication, telephone number data, ID number data of the device itself, and character data, for example, of an electronic mail. If the device has a function of electronically mailing picture data, it sends/receives picture or image data via the antenna 1.

The communication control unit 3 determines under control of a controller 4 which of the above-mentioned data the received data corresponds to. If the received data is voice data, the communication control unit 3 delivers the data to a voice control unit 5. If the received data is other than the voice data, the communication control unit 3 delivers it to the controller 4. When the communication control unit 3 receives the voice data from the voice control unit 5 and receives transmit character or image data from the controller 4, the communication control unit 3 delivers the data to the transmission/reception unit 2.

The voice control unit 5 comprises a voice codec circuit, which decodes received encoded voice data delivered from the communication control unit 3 to provide a voice signal, and delivers it to a converter 6 for sounding purposes. The voice control unit 5 encodes a voice signal provided via a cable 8 extending through a band 25, which will be described later in more detail, from a microphone based on a voice input given from the outside, and delivers the encoded data to the communication control unit 3.

The converter 6 converts the received voice signal to data for telephonic communication using infrared rays and delivers the data to a transmission unit (wireless transmission means, infrared transmission means) 9. The transmission unit 9 comprises an infrared emitting diode 91 (FIG. 6) and its driver (not shown), and transmits the voice in the form of an infrared signal 150 to a reception unit 201 of the second or finger-wearable device 200.

The controller 4 controls the whole first or wrist-wearable type device 100, and comprises a CPU which contains a micro program to execute a flow of the functions of the first device 100. The controller 4 delivers control signals to the transmission/reception unit 2, the communication control unit 3, the voice control unit 5, the converter 6 and the transmission unit 9 for controlling purposes, and as described above, sends/receives data to/from the voice communication control unit 3.

The controller 4 is connected to a timepiece circuit 10 which measures reference signals to acquire present time information such as present date and time. Thus, the controller 4 receives the present time information from the timepiece circuit 10. The controller 4 receives signals from a key-in unit 11 for fulfilling telephonic functions, for example, comprising turn-on/off of telephonic communication and input of a telephone number. The controller 4 is also connected to a memory 12 and a display unit 13.

The memory 12 comprises a RAM, an EEPROM or a flash memory which stores various data such as data sent/received by telephonic communication/electronic mail and a schedule/address book set by the user.

The display unit 13 comprises a color liquid crystal display device or a color EL (Electroluminescence) display device. Usually, the display device 13 digitally displays present time information provided by the timepiece circuit 10. When it is used as a telephone, it displays its sensitiveness to radio waves, received data, sentence data of an electronic mail to be sent, telephone number data, received mail sentence data and picture data.

The second or finger-wearable device 200 receives in a reception unit 201 an infrared voice signal sent by the transmission unit 9. It demodulates the received signal in a demodulator (demodulating means) 200 to provide a voice signal, which is then output as a corresponding sound from a speaker (sound generating means) 203.

When the second device 200 is used as the portable telephone, a radio signal received via the antenna 1 is converted by the transmission/reception unit 2 to an electronic voice signal, which is then delivered to the communication control unit 3. The voice signal is further decoded by the voice codec of the voice control unit 5. The resultant signal is then delivered to the converter 6 which provides a corresponding an infrared voice signal 150. The transmission unit 9 then transmits this signal to the reception unit 201 of the second or finger-wearable device 200. The signal is then demodulated by the demodulator 202, and then produced as a corresponding sound from the speaker 203.

The user's voice is input to the microphone 7, and encoded by the voice control unit 5. A resultant is then sent via the communication control unit 3 and the transmission/reception unit 2 to the antenna 1 for telephonic communication.

When the data received by the antenna 1 comprises character or picture data of an electronic mail, the data is delivered from the communication control unit 3 via the controller 4 to the memory 12 for storing purposes. Such data is read out from the memory 12 by operating a display command key of the key-in unit 11 (a particular one of key switches 16, 17, 18, as shown in FIG. 6) andthen displayed on the display unit 13.

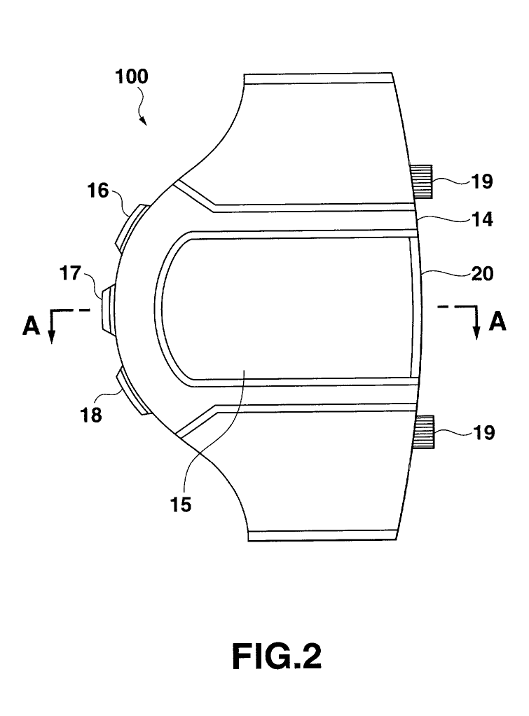

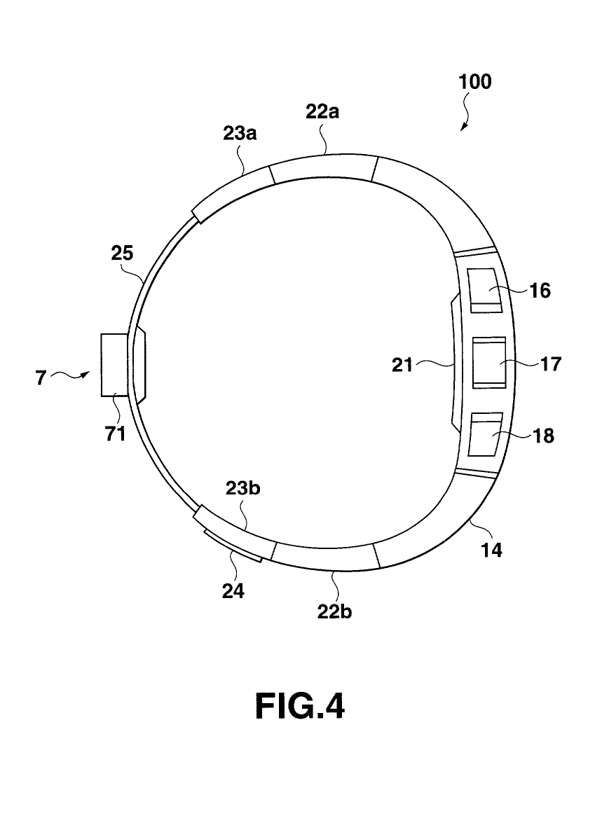

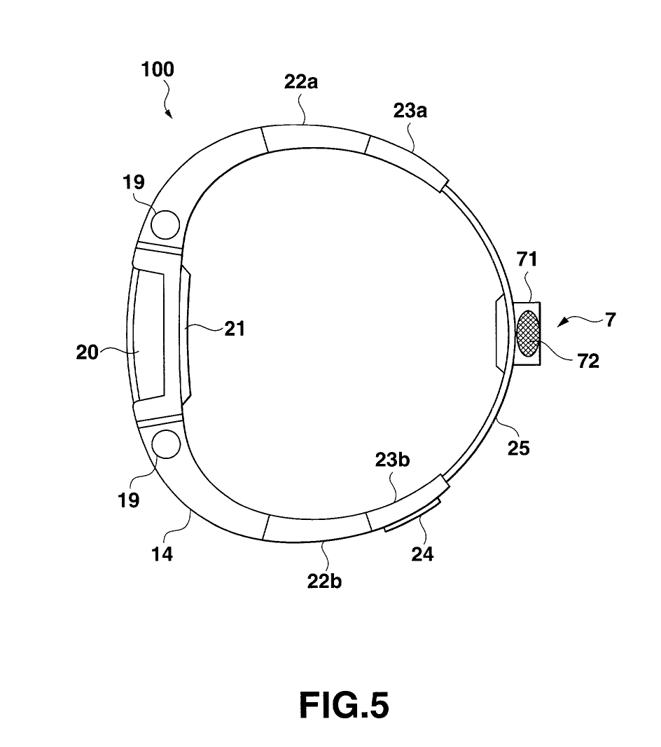

FIGS. 2-5 shows the appearance of the first device 100. FIGS. 2 and 3 are a front view and a back view, respectively, of the first device 100. FIGS. 4 and 5 are each a different side view of the first device 100.

As shown, the first device 100 is of a wristwatch-type. The first device 100 has a metal or resin body case 14 which is composed of a watch glass cover 15, and switches 16, 17 and 18 as control keys for telephone and timepiece functions (key-in unit 11). The first device 100 also has a pair of recharge terminals 19 through which batteries 28 (FIG. 6) which drive the respective elements of the first device 100 are recharged, a side glass cover 20, and a back cover 21.

The body case 14 is connected to a first pair of case pieces 22a and 22b and a second pair of case pieces 23a and 23b each made of a flexible resin material.

A disconnectable band connector 24 is provided on the case piece 23b. A cloth or leather band 25 is fixed at one end to the band connector 24 and at the other end to the case piece 23a. The microphone 7 is provided at a midpoint on the band 25 and connected to a circuit board 26 (FIG. 6) by a cable 8 which extends through the band 25, the case pieces 23a and 22a and the body case 14.

More specifically, when the microphone 7 is worn by the band 25 on the user's wrist, a front 72 of the microphone body 71 faces in the same direction as the user's fingers associated with the wrist extend. In this case, the side glass cover 21 faces in the direction where the user's palm concerned is present, or the side glass cover 212 of the case 210 worn on the user's middle finger.

FIG. 6 is a cross-sectional view of the body case 14 taken along a line A-A of FIG. 2. As shown, the circuit board 26, liquid crystal display panel 27, and battery 28 are enclosed within the body case 14. Provided on the circuit board 26 is an LSI 29, which comprises the components of the first device 100 excluding the antenna 1, microphone 7, transmission unit 9, key-in unit 11 and display unit 13, with the display panel 27 (display unit 13 of FIG. 1) being electrically connected at its internal terminals 30 to the circuit board 26. Provided below the circuit board 26 are electronic parts 32 and 33 (capacitors, a crystal resonator, etc.) of the timepiece/portable telephone outside a battery accommodating frame 31.

A switch terminal 34 is provided on a side of the circuit board 26 where the switches 16-18 are provided (FIG. 2). A light emitting diode (infrared ray transmitting means) 91 which composes the transmission unit 9 is provided on the side glass cover 20 side of the circuit board 26 and covered with the side glass cover 20. Terminals 92 of the diode 91 are electrically connected to the circuit board 26 and accommodated within a case 93 open to the side glass cover 20.

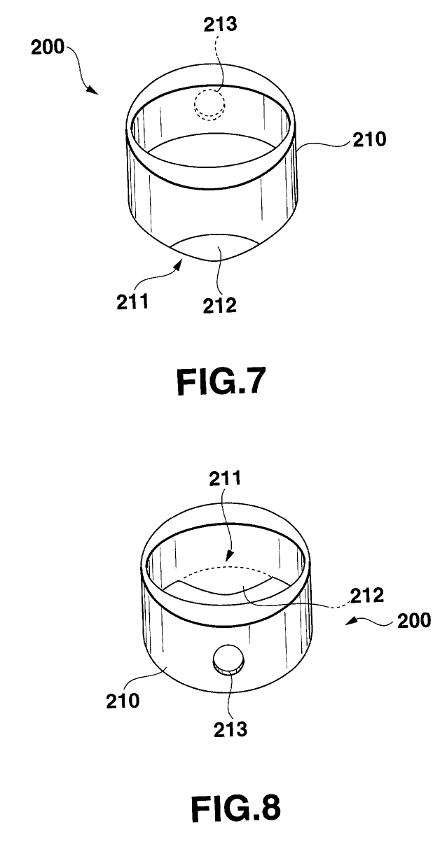

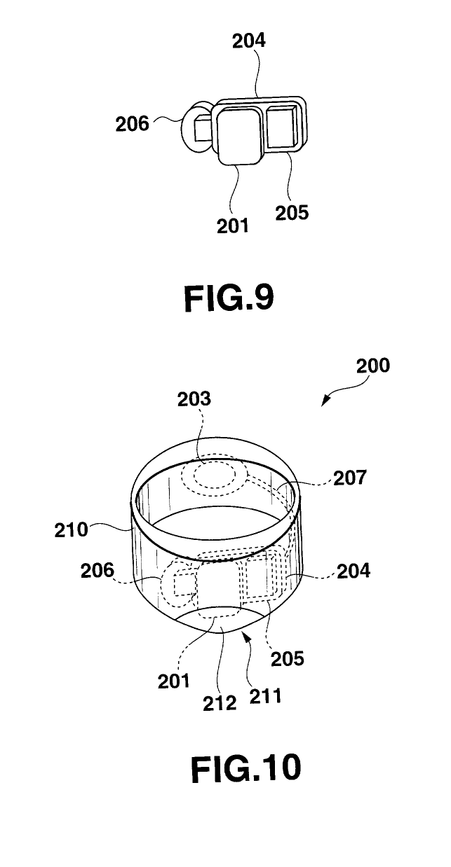

FIGS. 7 and 8 show an appearance of the second device 200. FIG. 9 shows electronic parts excluding a speaker 203 disposed within the second device 200. FIG. 10 shows electronic parts disposed within a finger ring case 210 of the second device 200. The case 210 has a reception unit accommodating section 211 whose side glass cover 212 protrudes in the same direction as the back of the user's hand faces. The case 210 also has a sound hole 213 provided so as to face in the same direction as the user's hand palm does when the second device 200 is worn properly on the user's hand.

As shown in FIG. 9, the reception unit 201 which contains a photo diode (infrared ray receiving means) is accommodated within the reception unit accommodating section 211 near the side glass cover 212. The reception unit 201 is also provided along with the LSI 205, which also includes the demodulator 202, and the battery 206 on the board 204

As shown in FIG. 10, the speaker 203 is disposed behind the sound hole 213 and is connected by a line 207 to the board 204.

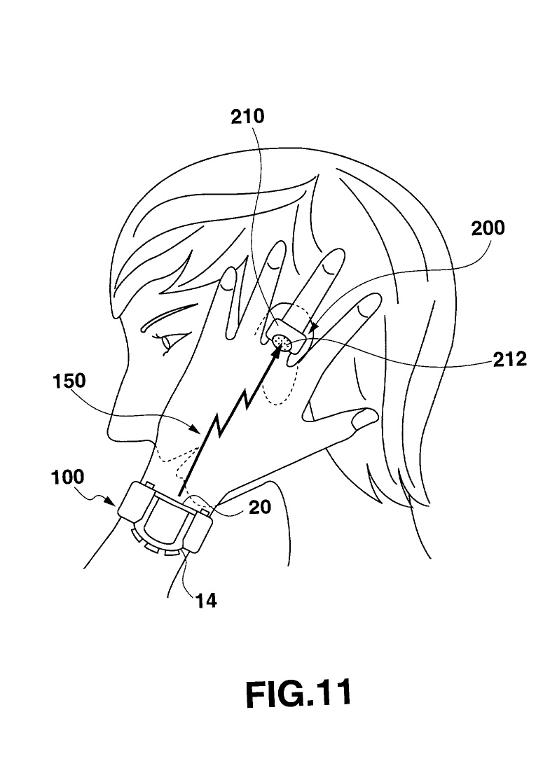

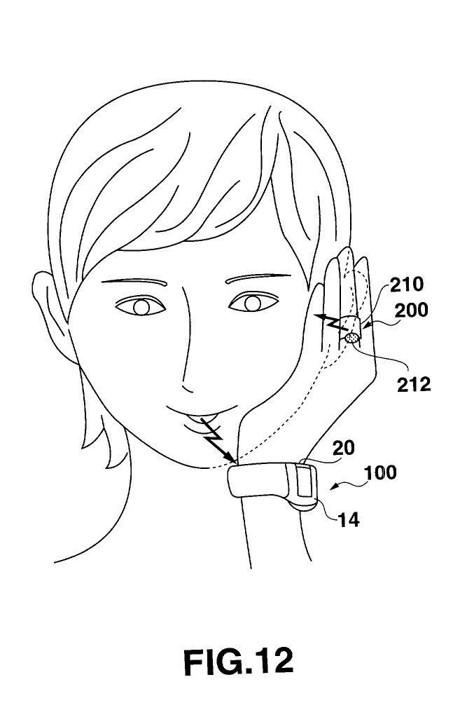

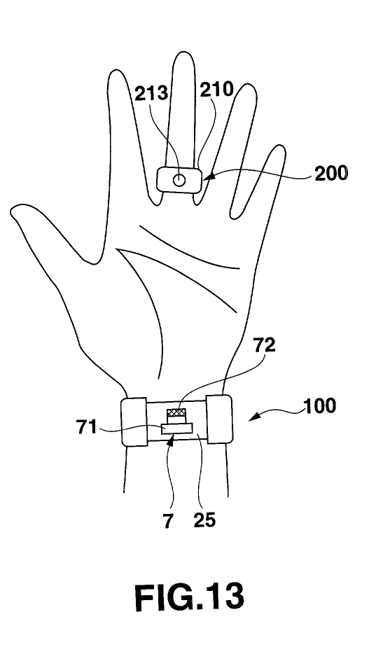

FIGS. 11-13 each show a use of the first and second devices 100 and 200. As shown in FIG. 13, the first device 100 and hence its case 14 are worn on the user's wrist such that the front 72 of the microphone 7 attached to the band 25 faces in the same direction as the user's fingers extend. The second device 200 in the form of a finger ring-type case 210 is worn on the user's finger (middle finger as shown, or first finger) such that the sound hole 213 faces in the same direction as the user's hand palm does. At this time, as shown in FIGS. 11 and 12, the side glass cover 20 of the body case 14 and the side glass cover 212 of the ring-type case 210 face in the same direction as the back of the user's hand does.

As shown in FIGS. 11 and 12, when the receiver is used as the portable telephone, the microphone 7 attached to the band 25 of the body case 14 which is worn on the user's wrist is brought close to the user's mouth. Also, the sound hole 213 in the ring-type case 210 worn on the user's finger is brought close to the user's ear as if the user rests his or her cheek on his or her hand.

When the user talks to the microphone in this state, his or her voice is inputted to the microphone 7. As described above, the voice is then encoded by the voice control unit 5 and the resulting voice data is then sent via the communication control unit 3 and the transmission/reception unit 2 to the antenna 1 and thence transmitted to the user's party.

The party's voice is transmitted in an infrared signal 150 from the transmission unit 9 (light emission diode 91) enclosed within the body case 14 of the first device 100 through its side glass cover 20 to the reception unit 201 (of a photodiode) through the side glass cover 212 of the ring-type case 210. The demodulator 202 demodulates the signal, and then outputs a corresponding sound from the speaker 203 through the sound hole 213.

While the first embodiment is illustrated as the receiver having the portable telephone function and comprising the first or wristwatch-type device and the second or finger ring-type device, the present invention is not limited to this particular embodiment. The receiver is only required to comprise a first or wrist-wearable device and a second or finger-wearable device. For example, the first or wristwatch-type device may receive a music or broadcast signal and the second or ring-type device may output a corresponding sound.

While it is illustrated that the first device sends an infrared voice signal to the second or finger ring-type device, transmission/reception of such signal may be performed after a communication link is established by sending/receiving some signals concerned. A transmission/reception format may follow any standards. Signals may be sent/received in radio waves other than the infrared rays. Designs for the first and second devices are optional. In addition, the specified details of the structures of the first and second devices may be changeable as requested, of course.

As described above, according to the first embodiment of the invention, radio waves are received by the first device worn on the user's wrist. Thus, the user is able to listen to a corresponding sound from the sound generating means of the second device worn on the user's finger by bringing his or her finger and hence the worn second device close to or into contact with the user's ear. This style in which the user applies his or her palm to his or her cheek or rests his or her cheek on his or her palm to think about something is very often encountered in his or her daily life, but does not give an unnatural impression to people around the user.

The sound generating means provided in the second device worn on the user's finger is applied to the user's ear. Thus, the sound generating means which generates a small amount of sound will suffice for such use, and may be small-sized. In addition, the first or wrist-wearable type device is not required to incorporate a large-volume sound generating means thereinto and hence is reduced in size and weight.

### Second Embodiment

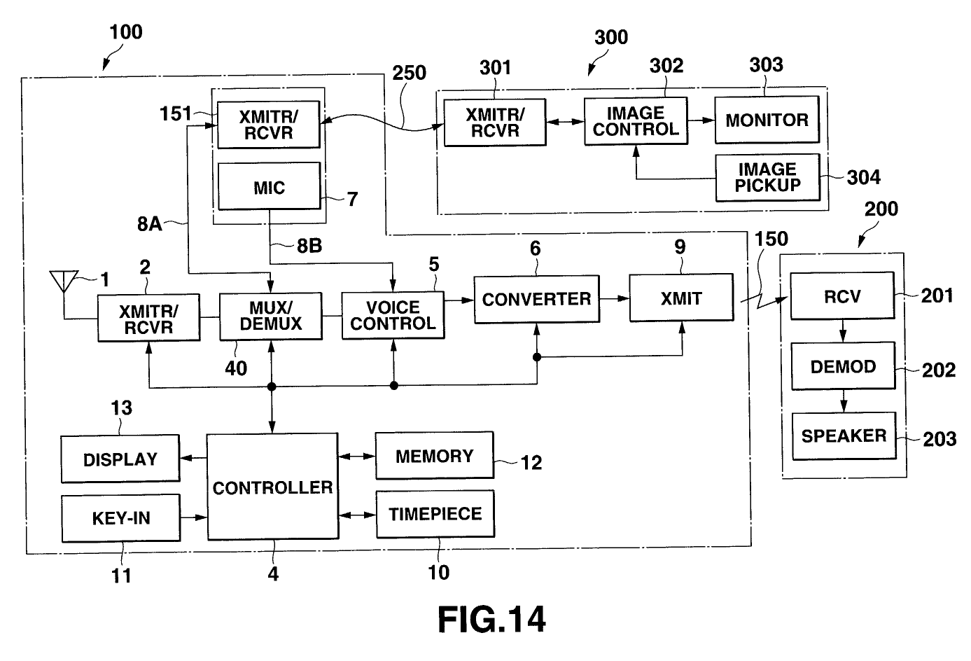

FIGS. 14-21, a second embodiment of the present invention will be described next. The same or similar elements of the first and second embodiments will be denoted by the same reference numeral, and further description thereof will be omitted.

FIG. 14 is a circuit diagram of a receiver of the second embodiment. The receiver is also constituted as a one wearable on a user's wrist and having the functions of a portable TV phone. This receiver comprises a first device 100 wearable on the user's wrist, a second or subreceiver 200 wearable on any finger (most preferably the middle one) of the user's hand having the same wrist as the first device 100 is worn on, and a third device 300 which is wearable on the user's other wrist or held by the user's other hand in use.

Data sent/received by a transmission/reception antenna 1 in the first device 100 comprises voice data for telephonic communication, telephone number data, receiver ID number data, character data of an electronic mail, TV phone image and voice data, mail and image data of the Internet, and picture data picked up by a camera, which will be described later in more detail.

When the data received by the antenna 1 is delivered to a multiplexer/demultiplexer unit 40, the multiplexer/demultiplexer unit 40 determines under control of the controller 4 which of those data mentioned above, the received data corresponds to, and separates them. That is, voice data of the received data is delivered to a voice control unit 5. Image data of the received data is delivered via a cable 8A to a picture transmission/reception unit 151 provided on the wristband 25. Character data and image data annexed to an electronic mail are delivered to the controller 4.

When the multiplexer/demultiplexer unit 40 receives voice data from the voice control unit 5, image data via the cable 8A from the image transmission/reception unit 151, and character data and/or image data for transmission from the controller 4, it multiplexes those data and delivers the resulting data as transmit data to the transmission/reception unit 2.

The voice control unit 5 comprises a voice codec circuit (not shown) which decodes the encoded voice data received from the multiplexer/demultiplexer unit 40 to provide a resulting voice signal, and then delivers the voice signal to a converter 6. When voice is inputted to the microphone 7 provided on the band 25, the voice control unit 5 receives a resulting voice signal from the microphone 7 via the cable 8B extending through the band 25, encodes the voice signal, and then delivers a resulting signal to the multiplexer/demultiplexer unit 40.

The third device 300 which is wearable on the user's other wrist or holdable by the user's other hand in use comprises an image transmission/reception unit 301 which sends/receives image data in an infrared signal 250 to/from the image transmission/reception unit 151 of the first device 100. The image transmission/reception unit 301 delivers the received image data to the image control circuit 302 to display the data on a monitor display unit 303. The image transmission/reception unit 301 also delivers the image data, picked up by an image pickup device (CCD) 304 of a camera (not shown) and received via the image control unit 302, in an infrared signal 250 to the image transmission/reception unit 151 of the first device 100.

The monitor display device 303 of the third device 300 monitors an image received from the user' party when the receiver is used as a TV phone. When a power source switch (not shown) is turned on, the third device 300 starts to operate to display the received image of the TV phone. Thus, the monitor display device 303 is composed, for example, of a TFT color liquid crystal display device or a color EL display device.

The monitor display device 303 may be constituted so as to not only monitor the TV phone, but also display an image electronic mail, an Internet image or character data received by the telephone of the first device 100. Thus, the display device 13 of the first device 100 may be omitted or small-sized.

The image pickup device 304 is a part of the camera which picks up a face of the user who wears this receiver. It delivers the picked-up image data to the first device 100 via the image control circuit 302 and the image transmission/reception unit 301.

When the receiver is not used as the TV phone, but as the portable telephone, the radio signal received via the antenna 1 is converted by the transmission/reception unit 2 to an electric signal, which is then delivered to the multiplexer/demultiplexer unit 40. A corresponding voice signal outputted from the unit 3 is decoded by the voice codec of the voice control unit 5, and a resulting signal is delivered to the converter 6. A resulting infrared signal produced from the converter 6 is then transmitted from the transmission unit 9 to a reception unit 201 of the subreceiver 200 worn on the user's finger. The signal received by the reception unit 201 is then demodulated by the demodulator 202 to a voice signal which is then output audibly from the speaker 203.

The user's voice is input to the microphone 7, which provides a corresponding voice signal. This signal is then encoded by the voice control unit 5. A resulting signal outputted from the unit 5 is then transmitted via the multiplexer/demultiplexer unit 40 and the transmission/reception unit 2 to the antenna 1 for communication between the portable telephones.

When the received data comprises character or image data of an electronic mail, the data is stored in a memory 12 via the multiplexer/demultiplexer unit 40 and the controller 4. In response to depression of a display command key (not shown) of the key-in unit, the data is read out from the memory 12 and displayed on the display device 13.

When the receiver is used as the TV phone, the radio signal received by the antenna 1 is converted by the transmission/reception unit 2 to an electric signal, which is then delivered to the multiplexer/demultiplexer unit 40. The image data (video data of the TV phone) is then delivered via the image transmission/reception unit 151 to a third device 300 and displayed on the monitor display device 303.

The received voice data is decoded by the voice codec of the voice control unit 5 and a resulting signal is delivered to the converter 6. The converter 6 delivers a corresponding infrared signal to the transmission unit 9, which then transmits the infrared signal to the reception unit 201 of the receiver 200 worn on the user's finger. The signal received by the reception unit 201 is demodulated by the demodulator 202 and a resulting voice signal is then output audibly from the speaker 203.

The image data picked up by the image pickup device 304 (video data sent by the TV phone) is delivered in an infrared signal via the image control unit 302, the image transmission/reception circuit 301 to the image transmission/reception unit 151 and then to the multiplexer/demultiplexer unit 40. The user's voice is input to the microphone 7 whose output is encoded by the voice control unit 5. A resulting voice signal outputted from the voice control unit 5 is then delivered to the multiplexer/demultiplexer unit 40, multiplexing the image data and the voice data. A resulting signal from the unit 3 is transmitted via the transmission/reception unit 2 from the antenna 1.

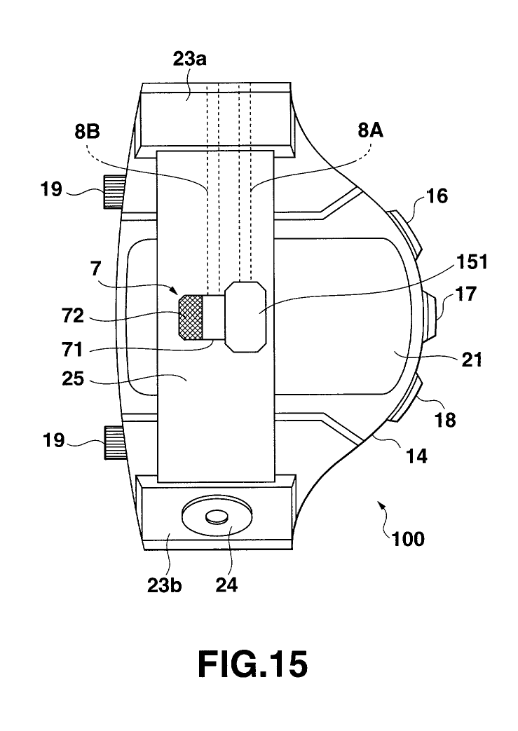

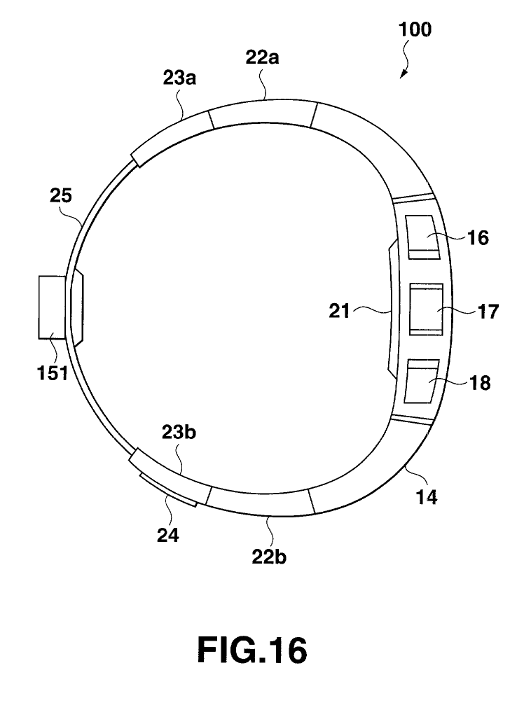

FIGS. 15 and 16 are a side view and a back view, respectively, of the first device 100. A band fixer 24 is provided unfixably on the case piece 23b such that a cloth or leather band 25 fixed unfixably by the fixer 24 at one end to the other case piece 23a is fixed at the other end to the case piece 23b. The microphone 7 and the picture transmission/reception unit 151 are provided at a midpoint on the band 25 and connected to a circuit board 26 (FIG. 6) by the cables 8A and 8B which extend through the band 25, the case pieces 23a and 22a and the body case 14.

More specifically, when the microphone 7 is worn on the user's wrist, a front 72 of the microphone body 71 faces in the same direction as the user's palm is present and hence the associated user's fingers extend. In this case, the radio transmission/reception unit 151 faces in a direction opposite to that in which the microphone 7 faces.

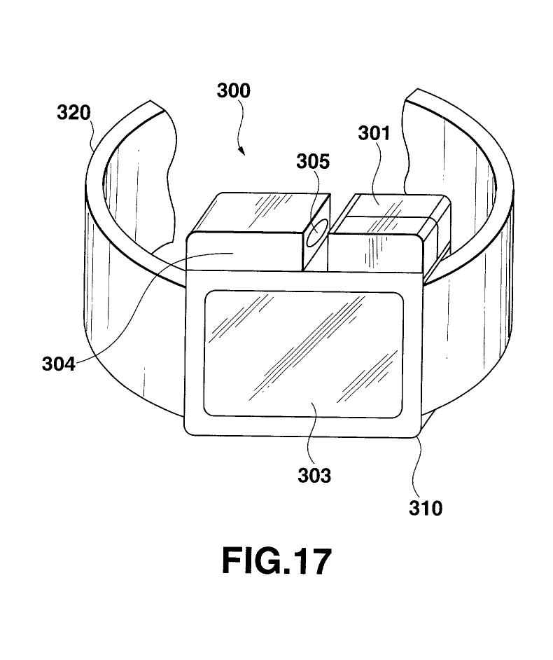

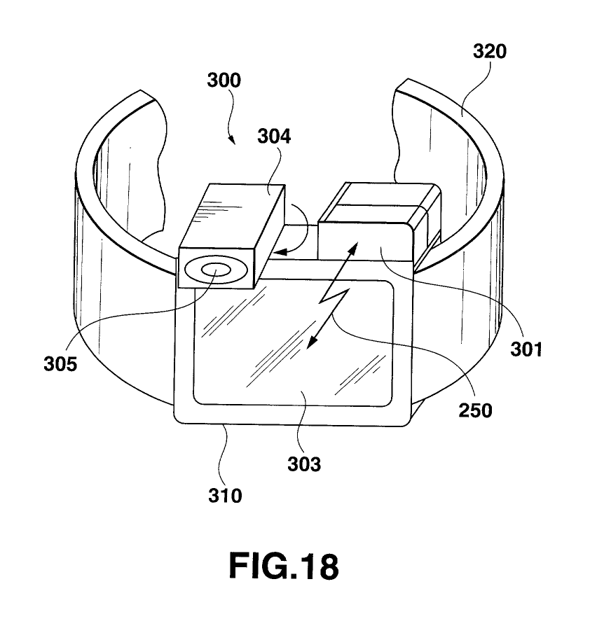

FIGS. 17 and 18 show the appearance of the third device 300, which is of the wristwatch-type device and having a metal or resin body case 310. The third device 300 comprises the image transmission/reception circuit 301 and the image pickup device 304 arranged on one side of the case 310, and the monitor display device 303 provided on an upper surface of the case 310 with a band 320 being connected to the case 310. The body case 310 contains the image control unit 302.

As shown in FIG. 18, the image transmission/reception circuit 301 comprises a light emitting diode which emits infrared rays and a photo sensor (not shown). It is fixed to the body case 310 such that its upper surface comprising the display screen of the monitor display device 303 constitutes an infrared communication surface. The image pickup device 304 is provided rotatably on the body case 310 such that an incident image is focused via the lens 305 on a CCD (not shown) provided within the image pickup 304 device to provide image data. That is, the image pickup device 304 is roratable between a position where the lens 305 of the image pickup device 304 faces the image transmission/reception circuit 301 and a position where the lens 305 of the image pickup device 304 faces in the same direction as the display screen of the monitor display device 303 does.

The third device 300 is worn on the user's wrist different from the user's other wrist on which the first device 100 is worn. The third device 300 may be held by the user's hand.

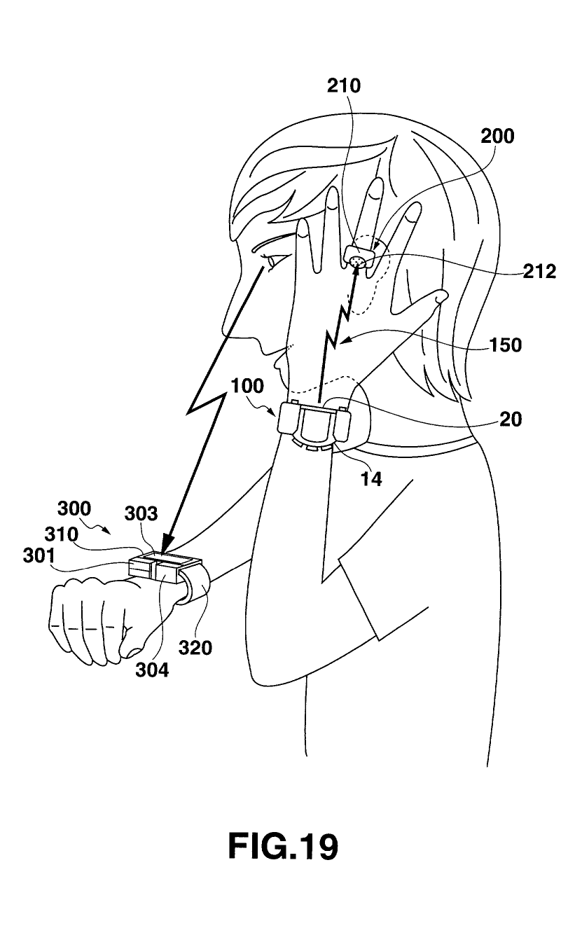

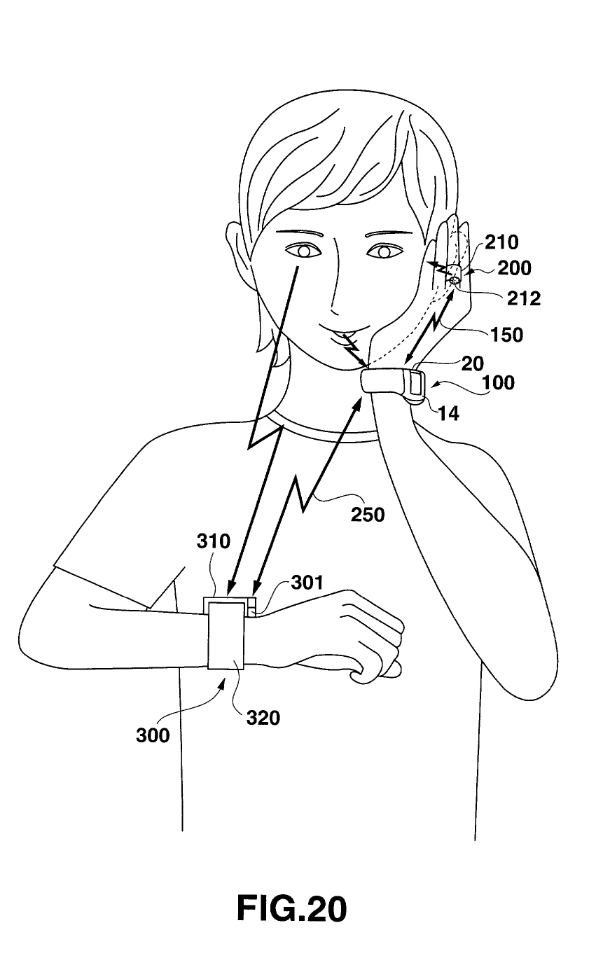

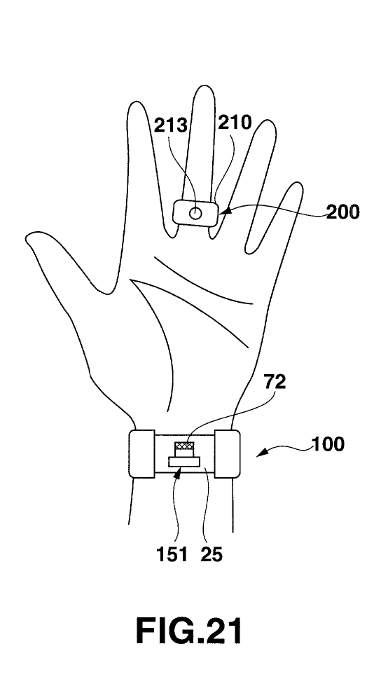

FIGS. 19 and 20 each show a use of the first, second and third devices 100, 200 and 300. FIG. 21 shows a use of the first and second devices 100 and 200. As shown in FIG. 21, for the first device 100, the body case 14 is worn on the user's left wrist such that the front 72 of the microphone 7 attached to the band 25 faces in the same direction as the user's middle finger extends. For the subreceiver 200, the finger ring-type case 210 is worn on a finger of the user's left-hand (middle finger as shown, or first or third finger) such that the sound hole 213 faces in the same direction as the user's left palm does. At this time, as shown in FIGS. 19 and 20, the side glass covers 20 and 212 of the body case 14 and the ring-type case 210 face each other.

For the third device 300, the body case 310 is worn by the band 20 on the user's right wrist such that the picture transmission/reception circuit 301 and the image pickup unit 304 face in the same direction as the back of the user's hand is present.

As shown in FIGS. 19 and 20, when the receiver is used as the portable telephone, the microphone 7 worn by the band 25 on the user's left wrist is brought close to the user's mouth, and the sound hole 213 in the ring-type case 210 worn on the user's finger is brought close to the user's ear as if the user rests his or her cheek on his or her left hand.

When the user talks to the microphone 7 in this state, his or her voice is inputted to the microphone 7. As described above, the voice is then encoded by the multiplexer/demultiplexer unit 40 and the resulting voice data is sent via the transmission/reception unit 2 to the antenna 1 and thence transmitted to the user's party.

The party's voice signal received by the antenna 1 is processed as mentioned above by the first device 100 and a resultant is sent in an infrared signal 150 from the transmission unit 9 (light emission diode 91) enclosed within the body case 14 through the side glass cover 20 to the reception unit 201 (of a photo diode) of the second device 200 through the side glass cover 212 of its ring-type case 210. The reception unit 201 demodulates the received signal to a voice signal in the demodulator 202, and the voice signal is then output audibly as a sound from the speaker 203 through the sound transmission hole 213.

When the receiver is used as the portable TV phone, as shown in FIGS. 19 and 20, a radio image signal sent by the image transmission/reception unit 151 of the first device 100 which is worn by the band 25 on the user's left wrist is inputted to the image transmission/reception circuit 301 of the third device 300 worn on the user's right wrist positioned down. Thus, an image is displayed on the monitor display device 303 of the third embodiment 300.

The image data representing, for example, an image of the user picked up by the image pickup device 304 is inputted in an infrared signal 250 from the image transmission/reception circuit 301 to the image transmission/reception unit 151 of the first device 100, and then transmitted via the multiplexer/demultiplexer unit 40, the transmission/reception unit 2 from the antenna 1 to the user's party.

While in the second embodiment the TV phone has been illustrated, for example, music or other broadcasts may be received by the first or wristwatch-type device. In this case, the user is able to listen to the music or broadcasts from the finger ring-type subreceiver and to view an image on the third device. Home page information and various content information containing voice data/image data can be listened to/viewed by the receiver via a telephone line from the Internet/various networks.

While the first device is illustrated as sending an infrared voice signal to the finger ring-type subreceiver, transmission/reception of such signal may be performed after a communication link is established by sending/receiving some signals concerned. A transmission/reception format may follow any standards.

Signals may be sent/received wirelessly in radio waves other than the infrared rays. Designs for the first-third devices are optional. In addition, the specified details of the structures of the first-third devices may be changeable as requested, of course.

As described above, according to the invention of the second embodiment, the first device worn on the user's wrist is capable of receiving of voice/image radio waves; transmitting a radio image signal to the third device worn on the user's other wrist; and displaying the radio image signal on the display means. Thus, although the receiver is of the portable type, it is capable of receiving the party's voice and viewing the party's image very well.

What is claimed is:

1. A receiver comprising:
a first or wrist-wearable type device comprising radio receiving means for receiving radio waves, converting means for converting the radio signal received by said radio wave receiving means to receive data and for outputting the same, and radio transmitting means for converting the receive data outputted by said converting means to a radio signal to transmit the same; and
a second or ring-wearable type device comprising radio receiving means for receiving the radio signal transmitted by said radio transmitting means of said first device, and sound generating means for generating a sound based on the radio signal received by said radio receiving means.

2. A receiver comprising:
a first or wrist-wearable type device comprising radio wave transmission/reception means for transmitting/receiving radio waves, transmission/reception control means for converting the radio waves received by said radio wave transmission/reception means to received data and for sending transmit data to said radio wave transmission/reception means for transmitting purposes, transmit data feeding means for feeding the transmit data to said transmission/reception control means, and radio transmitting means for converting the receive data provided by said transmission/reception control means to a radio signal and for transmitting the same; and
a second or ring-wearable type device comprising radio receiving means for receiving the radio signal transmitted by said radio transmitting means of said first device, and sound generating means for generating a sound based on the radio signal received by said radio receiving means.

3. The receiver according to claim 1, wherein said radio transmitting means of said first device comprises infrared ray transmitting means, and said radio receiving means of said second device comprises infrared ray receiving means.

4. The receiver according to claim 2, wherein said radio transmitting means of said first device comprises infrared ray transmitting means, and said radio receiving means of said second device comprises infrared ray receiving means.

5. The receiver according to claim 1, further comprising a band provided for said first device to wear said first device on a user's wrist and wherein when said first device is worn by said band on the user's wrist, said radio transmitting means is disposed at a position where said radio transmitting means faces in the same direction as the user's fingers associated with the wrist extend.

6. The receiver according to claim 2, further comprising a band provided for said first device to wear said first device on a user's wrist and wherein when said first device is worn by said band on the user's wrist, said radio transmitting means is disposed at a position where said radio transmitting means faces in the same direction as the user's fingers associated with the wrist extend.

7. The receiver according to claim 1, wherein said second device takes the form of a finger ring such that when said second device is worn on a user's finger, said radio receiving means is disposed on a back of the user's hand and that said sound generating means is disposed on the side of the user's palm.

8. The receiver according to claim 2, wherein said second device takes the form of a finger ring such that when said second device is worn on a user's finger, said radio receiving means is disposed on a back of the user's hand and that said sound generating means is disposed on the side of the user's palm.

9. The receiver according to claim 2, wherein said transmit data feeding means comprises a microphone for receiving voice to convert the voice to a voice signal, and voice signal control means for feeding the voice signal as transmit data to said transmission/reception control means, and further comprising a band to be wound around the user's wrist to wear said first device on the user's wrist, said microphone being provided on the user's palm side of said band.

10. A receiver comprising a first or wrist-wearable type device which comprises radio wave transmission/reception means for transmitting/receiving voice radio waves, transmission/reception control means for converting the voice radio waves received by said radio wave transmission/reception means to receive voice data and for sending transmit voice data to said radio wave transmission/reception means for transmitting the transmit voice data as radio waves, transmit voice data feeding means for feeding the transmit voice data to said transmission/reception control means, and infrared transmitting means for converting to an infrared signal the receive voice data received by said transmission/reception control means for transmitting purposes; and
a second or ring-wearable type device comprising infrared receiving means for receiving the infrared signal transmitted by said infrared transmitting means of said first device and sound generating means for generating a sound based on the infrared signal received by said infrared receiving means.

11. A receiver comprising a first or wrist-wearable type device which comprises radio wave receiving means for receiving voice and image radio waves, converting means for converting the voice and image radio waves received by said radio wave receiving means to voice and image data, sound generating means for generating a sound based on the voice data, and radio image signal transmitting means for converting the image data to a radio image signal and for transmitting the same; and
a second device comprising radio image receiving means for receiving the radio image signal transmitted by said radio image transmitting means of said first device and display means for displaying image data based on the radio image signal received by said radio image receiving means.

12. A receiver comprising:
a first or wrist-wearable type device which comprises radio wave receiving means for receiving voice and image radio waves, converting means for converting the voice and image radio waves received by said radio wave receiving means to voice and image data and to provide the same, radio voice signal transmitting means for converting the radio voice data provided by said converting means to a radio voice signal to transmit the same, and radio image signal transmitting means for converting the image data provided by said converting means to a radio image signal and for transmitting the same;
a finger-wearable subreceiver for receiving the radio voice signal transmitted by said radio voice signal transmitting means of said first device and for outputting a corresponding sound, and
a second device for receiving the radio image signal transmitted by said radio image signal transmitting means and for displaying a corresponding image.

13. The receiver according to claim 11, wherein said radio image transmitting means of said first device transmits the radio image signal on infrared rays.

14. The receiver according to claim 12, wherein said radio image transmitting means of said first device transmits the radio image signal on infrared rays.

15. The receiver according to claim 12, further comprising a band provided to wear said first device on a user's wrist and wherein when said first device is worn by said band on the user's wrist, said radio voice signal transmitting means is disposed at a position where said radio wave transmitting means faces in the same direction as the user's fingers associated with the wrist extend.

16. The receiver according to claim 12, wherein when said finger-wearable subreceiver is properly worn on the user's finger, said finger-wearable subreceiver comprises voice signal receiving means provided on the side of a back of the user's hand for receiving a radio voice signal and sound generating means provided on the side of the user's palm.

17. The receiver according to claim 11, wherein said first device further comprises a band for wearing said first device on a user's wrist, and a microphone for receiving voice and said radio image transmitting means, provided on the user's palm side.

18. The receiver according to claim 12, wherein said first device further comprises a band for wearing said first device on a user's wrist, and a microphone for receiving voice and said radio image transmitting means, provided on the user's palm side.

19. The receiver according to claim 11, wherein said second device further comprises an image pickup device for picking up an image of an object, and means for feeding to said first device image data representing the image of the object picked up by said image pickup device.

20. The receiver according to claim 12, wherein said second device further comprises an image pickup device for picking up an image of an object, and means for feeding to said first device image data representing the image of the object picked up by said image pickup device.

21. A receiver comprising:
a first or wrist-wearable type device which comprises radio wave transmitting/receiving means for transmitting/receiving voice and image radio waves, transmission/reception control means for converting the voice and image radio waves received by said radio wave transmitting/receiving means to receive voice and image data and for sending transmit voice and image data to said radio wave transmitting/receiving means for transmitting purposes, transmit voice data feeding means for feeding the transmit voice data to said transmission/reception control means, radio voice signal transmitting means for converting the receive voice data provided by said transmission/reception control means to a radio voice signal and for transmitting the radio voice signal, and radio image feeding means for feeding transmit image data to said transmission/reception control means, for converting the receive image data provided by said transmission/reception control means to a radio image signal and for transmitting the same;
a finger-wearable subreceiver comprising radio voice signal receiving means for receiving the radio voice signal transmitted by said radio voice signal transmitting means of said first device and sound generating means for generating a sound based on the radio voice signal received by said radio voice signal receiving means; and
a second device comprising radio image signal receiving means for receiving the radio image signal transmitted by said radio image signal transmitting means of said first device and display means for displaying an image based on the radio image signal received by said radio image signal receiving means.
